(19) United States
(12) Patent Application Publication
(10) Pub. No.: US 2024/0304992 A1
(43) Pub. Date: Sep. 12, 2024

(54) ANTENNAS INCLUDING A PARASITIC ELEMENT COUPLED TO AN ACTIVE ELEMENT

(71) Applicant: CommScope Technologies LLC, Hickory, NC (US)

(72) Inventor: Huan Wang, Richardson, TX (US)

(21) Appl. No.: 18/549,235

(22) PCT Filed: Jan. 25, 2022
(86) PCT No.: PCT/US2022/013612

§ 371 Date: Sep. 6, 2023

Related U.S. Application Data
(60) Provisional application No. 63/160,248, filed on Mar. 12, 2021.

(51) Int. Cl. H01Q 5/385; H01Q 9/42; H01Q 19/32; H01Q 21/24

(52) U.S. Cl. CPC H01Q 5/385; H01Q 9/42; H01Q 19/32; H01Q 21/24

(57) ABSTRACT

Antennas are provided herein that include a parasitic element that is coupled to an active element and a ground plane. In some embodiments, the active element is inside an outline provided by a combination of the parasitic element and the ground plane. Moreover, the active element and the parasitic element are, in some embodiments, on opposite surfaces, respectively, of a printed circuit board.

### CROSS-REFERENCE TO RELATED APPLICATION

The present application claims priority to U.S. Provisional Patent Application No. 63/160,248, filed Mar. 12, 2021, the entire content of which is incorporated herein by reference.

### FIELD

The present disclosure relates to antennas and, more particularly, to antennas having a parasitic element.

### BACKGROUND

Small-cell base stations, distributed antenna systems (“DASs”), and Wi-Fi access points are examples of systems/apparatuses that can provide in-building and outdoor wireless communications service to end-users (e.g., subscribers) at a lower cost and lower power consumption than macrocell base stations. Compact monopole antennas are widely used in such low-cost, low-power systems/apparatuses. Typical compact monopole antennas include, for example, a planar inverted-F antenna (“PIFA”), a T-antenna, and a folded monopole antenna. Band aggregation at the system level, however, can create demand for wider bandwidths than conventional compact monopole antennas typically provide.

### SUMMARY

An antenna, according to some embodiments herein, may include a ground plane. The antenna may include a parasitic element coupled to the ground plane. The antenna may include an active element having a vertical portion and a horizontal portion that are each inside an outline provided by a combination of the parasitic element and the ground plane. The parasitic element may be coupled to the active element.

In some embodiments, the parasitic element may have a symmetrical shape. For example, the active element and the parasitic element may be T-shaped and Pi-shaped radiating elements, respectively.

According to some embodiments, the active element may be centered between vertical legs of the outline. In other embodiments, the parasitic element may include first and second vertical portions, and the vertical portion of the active element may be closer to the second vertical portion of the parasitic element than to the first vertical portion of the parasitic element.

In some embodiments, the antenna may include a substrate having a first surface and a second surface that is opposite the first surface. The parasitic element and the active element may be on the first surface of the substrate and the second surface of the substrate, respectively. The ground plane may be a ground plane of a printed circuit board, and the substrate may be on a surface of the printed circuit board. Moreover, the printed circuit board may have first and second plated through hole vias therein, and the parasitic element may include first and second vertical portions that are coupled to the ground plane through the first and second plated through hole vias, respectively.

A monopole antenna, according to some embodiments herein, may include a parasitic element having a horizontal portion and first and second vertical portions. The monopole antenna may include an active element having a vertical portion and a horizontal portion. Moreover, the parasitic element of the monopole antenna may be inductively and/or capacitively coupled to the active element of the monopole antenna.

In some embodiments, the parasitic element may be both capacitively coupled and inductively coupled to the active element. For example, the horizontal portion of the parasitic element may be capacitively coupled to the horizontal portion of the active element, and at least one of the first and second vertical portions of the parasitic element may be inductively coupled to the vertical portion of the active element.

An antenna, according to some embodiments herein, may include an active portion and a parasitic portion that are on opposite surfaces, respectively, of a first printed circuit board.

In some embodiments, the antenna may include a second printed circuit board having a surface that has the first printed circuit board thereon. Opposite surfaces of the first printed circuit board may be perpendicular to the surface of the second printed circuit board.

According to some embodiments, the second printed circuit board may include first and second plated through hole vias therein, and the parasitic portion of the antenna may be grounded through the first and second plated through hole vias.

In some embodiments, the parasitic portion of the antenna may include a horizontal portion having a first length, and a second length from a top of the horizontal portion to the surface of the second printed circuit board may be shorter than the first length.

According to some embodiments, the parasitic portion of the antenna may include: a horizontal portion extending a first distance in a direction parallel to the surface of the second printed circuit board; and first and second vertical portions that are spaced apart from each other by a second distance that is shorter than the first distance.

In some embodiments, the parasitic portion of the antenna may be both capacitively coupled and inductively coupled to the active portion of the antenna.

According to some embodiments, the active portion of the antenna may be a straight line on the first printed circuit board.

In some embodiments, the active portion of the antenna may include a horizontal portion and a vertical portion.

### BRIEF DESCRIPTION OF THE DRAWINGS

FIG. 1 is a schematic diagram illustrating the increasing data connectivity needs for information and communication technology infrastructure.

FIG. 2A is a front shadow perspective view of an antenna according to embodiments of the present invention.

FIG. 2B is a schematic front view of a substrate of the antenna of FIG. 2A.

FIG. 2C is a schematic rear view of the substrate of FIG. 2B.

FIGS. 2D-2G are schematic rear views of modified embodiments of the antenna of FIGS. 2A-2C.

FIG. 2H is a schematic top view of an antenna according to further embodiments of the present invention.

FIGS. 2I-2L are front perspective views of various antennas having two parasitic elements coupled to an active element.

### DETAILED DESCRIPTION

Embodiments of the present invention provide compact antennas that have broadened radio frequency (“RF”) bandwidth, where the RF bandwidth refers to the frequency range where the return loss between the antenna and its feed network meet a specified value, such as a return loss of at least 10 decibels (“dB”). A conventional folded monopole antenna, for example, may have a compact size but also a relatively narrow RF bandwidth. In such a conventional folded monopole, only the vertically-extending “legs” of the antenna may radiate. The horizontal arms of the folded monopole reduce the height of the vertically-extending legs of the antenna, but typically do not radiate. Rather, currents in the horizontal arms may cancel each other. One vertical leg of the folded monopole may be coupled to a feeding point, and another vertical leg of the folded monopole may be coupled to ground. The folded monopole may be used as, for example, a cell phone antenna.

Another example of a conventional compact monopole antenna is a T-shaped monopole. As with the above-discussed folded monopole, the T-shaped monopole may have a vertically-extending leg and a horizontal arm that extends from the distal end of the leg in two directions so that the leg and the arm together form a “T” shape. The horizontal arm helps to reduce the height of the vertically-extending leg of the antenna. In one conventional implementation, the T-shaped monopole is formed on a vertical printed circuit board (“PCB”) and the base of the vertically-extending leg is coupled to a feeding line that is on a horizontal PCB. Currents on left and right sides of the horizontal arm of the T-shaped monopole may cancel each other out such that the horizontal arm does not radiate. Rather, only the vertically-extending leg of the T-shaped monopole may radiate. Likewise, only vertical parts of a PIFA, which is a further example of a conventional compact monopole antenna, may radiate.

The bandwidth of antennas according to embodiments of the present invention may be expanded relative to that of a conventional compact monopole antenna while maintaining a compact size. For example, the antennas according to embodiments of the present invention may be approximately the size of a conventional T-shaped monopole that is designed to operate in a frequency band having the same center frequency as the antennas according to embodiments of the present invention. The antennas according to embodiments of the present invention may include a parasitic element, and coupling between the parasitic element and an active element of the antenna may result in an RF signal delay that expands a lower end of a frequency range of the antenna.

Example embodiments of the present invention will be described in greater detail with reference to the attached figures.

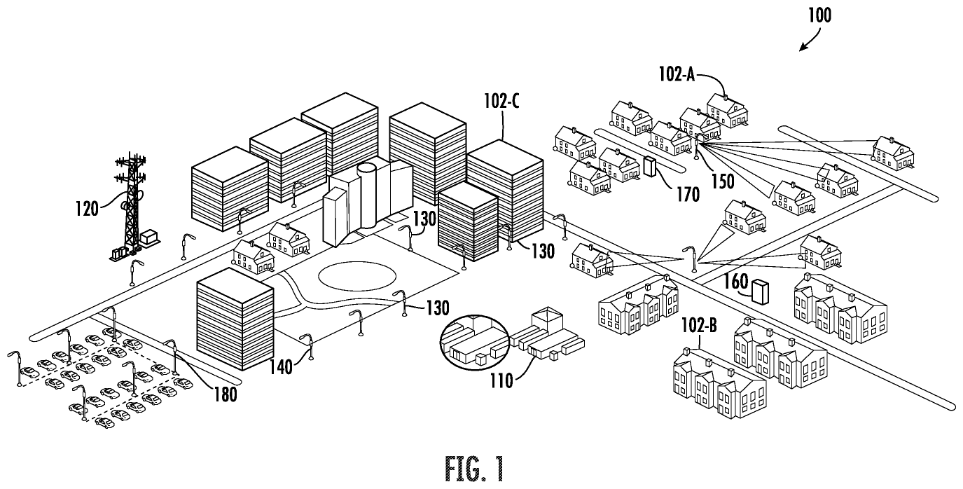

FIG. 1 is a schematic diagram illustrating the increasing data connectivity needs for information and communication technology infrastructure. As shown in FIG. 1, in an urban or suburban environment 100, a communications provider, such as a cellular network operator, may operate a central office 110 and a macrocell base station 120. In addition, the communications provider may operate a plurality of small-cell base stations 130, Wi-Fi access points 140, fixed wireless nodes 150, active cabinets 160 (e.g., for fiber), DSL (e.g., G.fast) distribution points 170, security cameras 180, and the like. FIG. 1 also illustrates a plurality of buildings 102, including single-family houses 102-A, multi-unit commercial and/or residential buildings 102-B, and office/industrial buildings 102-C where cellular or other communications service may be desired.

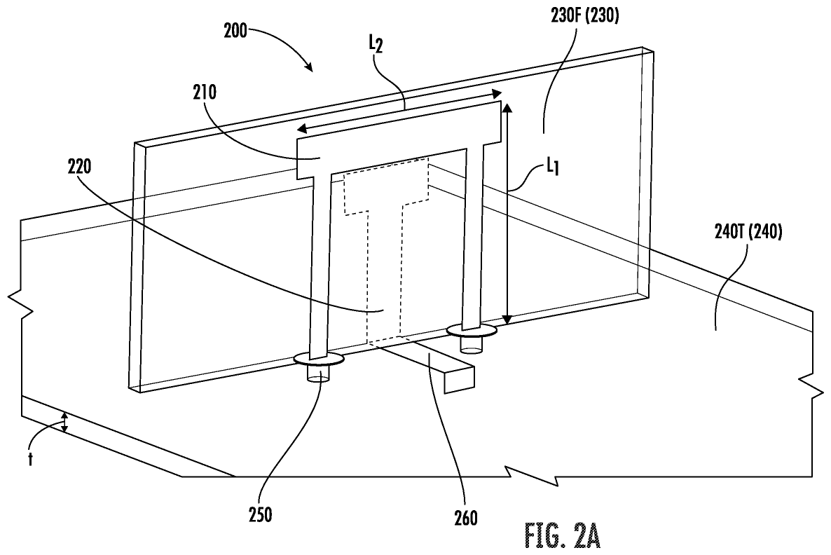

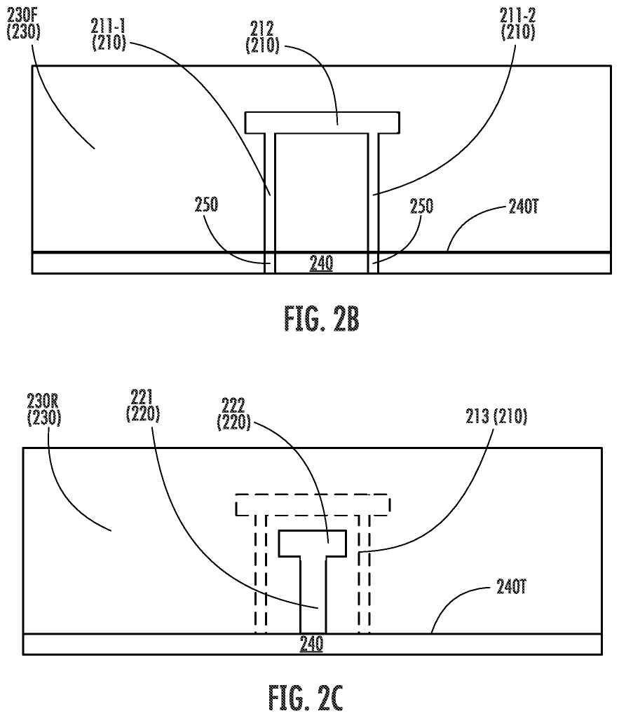

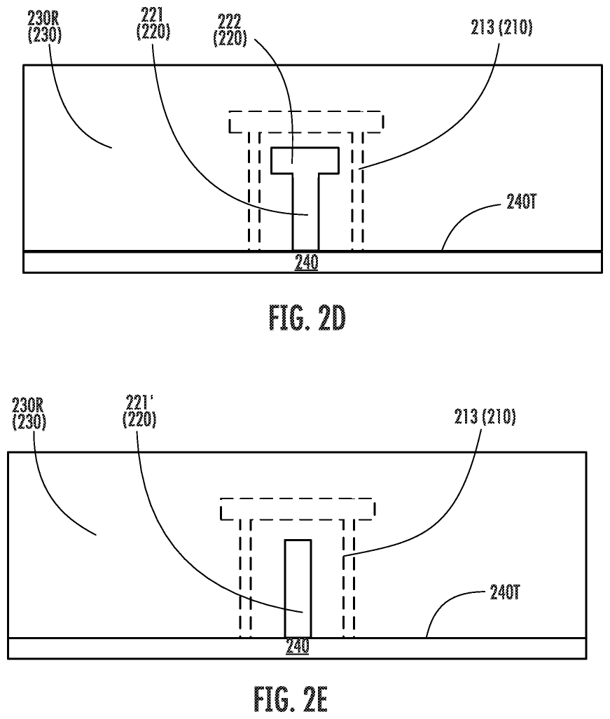

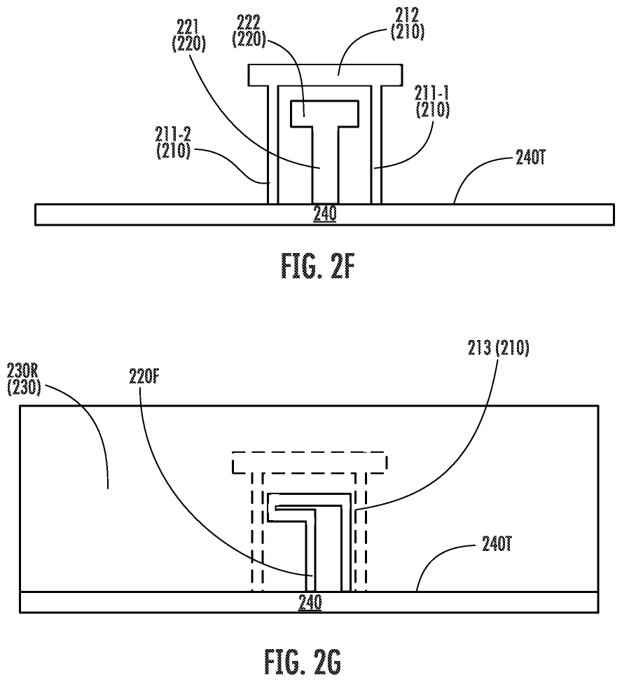

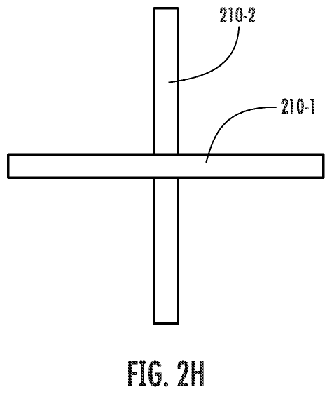

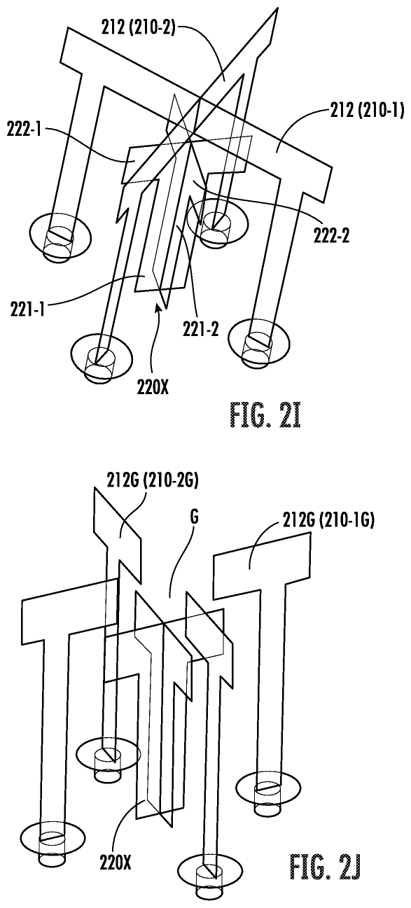

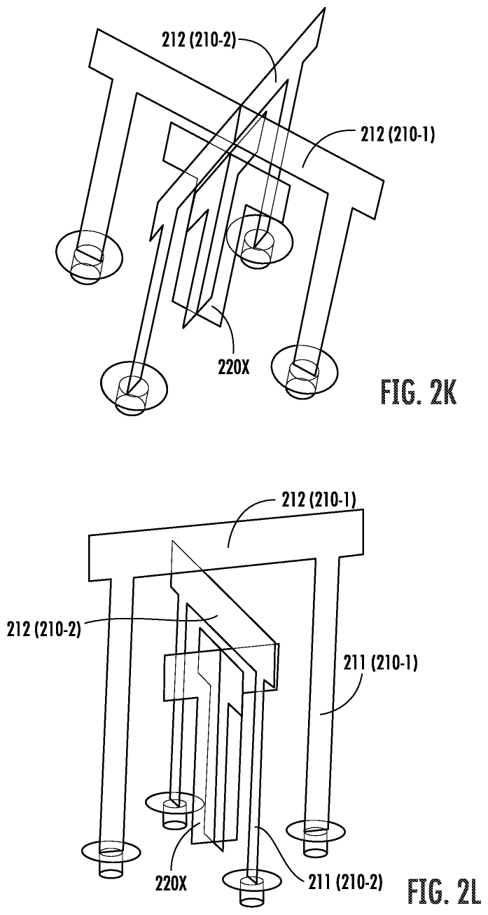

FIG. 2A is a front shadow perspective view of an antenna 200 according to embodiments of the present invention. The antenna 200 includes an active element 220 and a parasitic element 210. The parasitic element 210 may be formed (e.g., printed) on a front surface 230F of a vertically-extending substrate 230. In some embodiments, the substrate 230 may be a substrate of a PCB. For simplicity of illustration, the substrate 230 is depicted as being transparent, thus revealing the active element 220 of the antenna 200 that is on an opposite, rear surface 230R (FIG. 2C) of the substrate 230. By printing the parasitic element 210 and the active element 220 on opposite surfaces of the substrate 230, the overall size of the antenna 200 may be reduced, as the parasitic element 210 and the active element 220 might otherwise need more space between each other to reduce coupling if they were on the same surface of the substrate 230. The substrate 230 may, in some embodiments, be one of various non-transparent substrates, such as a dielectric substrate that is not transparent.

The active element 220 and the parasitic element 210 may each be metal (e.g., copper) elements that are electrically coupled to each other when the antenna 200 operates. For example, the active element 220 and the parasitic element 210 may have hybrid coupling therebetween, such as both capacitive coupling and inductive coupling. Accordingly, the total coupling may be a combination of capacitive coupling and inductive coupling. As a result of the coupling, the metal of the parasitic element 210 may resonate as if it were physically connected to the active element 220, thus providing a wider bandwidth for the antenna 200.

Moreover, the antenna 200 may, in some embodiments, be a monopole antenna that has similar overall dimensions to those of a conventional T-shaped monopole. The active element 220, which may be smaller than a conventional T-shaped monopole, may thus be a type (e.g., T-shaped or other shape) of monopole active element. Because their overall sizes may be similar, radiation patterns generated by the antenna 200 and the conventional T-shaped monopole may also be similar. In some embodiments, the antenna 200 may radiate sideways/horizontally (rather than vertically), which may be advantageous for various applications, such as implementation in a small-cell base station 130 (FIG. 1) or a macrocell base station 120 (FIG. 1).

The active element 220 may be fed by (e.g., directly connected to) a feeding line 260 that is on a horizontally-extending PCB 240. The horizontally-extending PCB 240 may, for example, comprise a dielectric substrate that has a metal ground plane on its lower surface and a metal feeding line 260 on its upper (e.g., top) surface 240T that together form a microstrip feed line for the antenna 200. For example, a portion of the feeding line 260 may extend under a bottom edge of the vertically-extending substrate 230 to physically and electrically contact the active element 220. In an example embodiment, a solder joint may physically and electrically connect the active element 220 to the feeding line 260. The parasitic element 210, by contrast, may be grounded through plated through hole (“PTH”) vias 250 that are in the PCB 240. The PTHs 250 may physically and electrically connect the base of each leg of the parasitic element 210 to the ground layer on the horizontally-extending PCB 240. In some embodiments, the feeding line 260 may extend between a pair of the PTH vias 250. The parasitic element 210 may not be connected to any feeding line. The parasitic element 210 may thus also be referred to herein as a “passive element” or a passive/parasitic “portion” of the antenna 200, and the active element 220 may also be referred to herein as an “active portion” of the antenna 200. The feeding line 260, unlike the active element 220 and the parasitic element 210, does not radiate.

The substrate 230 may be on a top surface 240T of the PCB 240. As an example, the substrate 230 (or a projection thereof) may intersect a longitudinal dimension of the top surface 240T. Moreover, the front and rear surfaces 230F, 230R of the substrate 230 may, in some embodiments, each be perpendicular to the top surface 240T. It will be appreciated that modifications may be made to the above antenna design. For example, in other embodiments, the ground plane may be on the top surface 240T of the PCB 240 and the feeding line 260 may be on the opposite (i.e., bottom) surface of the PCB 240. Accordingly, the top surface 240T may represent a ground plane. In these other embodiments, the PTH vias 250 may be used to electrically connect the feeding line 260 to the active element 220, and the parasitic element 210 may be directly connected to the ground plane (e.g., through solder joints).

The top of the parasitic element 210 may have a height, relative to the top surface 240T, of L₁. The parasitic element 210 may also have a width, along a longitudinal dimension of the front surface 230F, of L₂. The longitudinal dimension of the front surface 230F may be parallel to the top surface 240T. The height L₁ may be shorter than the width L₂. For example, the height L₁ may have a value of 0.15*λ and the width L₂ may have a value of 0.16*λ, where λ is the free space wavelength at the center frequency of the antenna 200. As an example, the center frequency of the operating frequency band of the antenna 200 may be 4.0 gigahertz (“GHz”) for a voltage standing wave ratio (“VSWR”)<2 bandwidth from about 3.35 GHz to about 4.66 GHz. As a result, relative bandwidth (bandwidth divided by center frequency) of the antenna 200 may be 10% wider than that of a conventional T-shaped monopole that is not coupled to a parasitic element. Moreover, as dimensions of the conventional T-shaped monopole may also be 0.16*λ in width by 0.15*λ in height, the antenna 200 may be as compact (or nearly as compact) as the conventional T-shaped monopole. The height L₁, the width L₂, the center frequency, and the bandwidth of the antenna 200 are not limited, however, to these example values.

An operating frequency of the antenna 200 may be estimated by:

$${f}_{0} = \frac{c}{λ} = \frac{c}{4 ( {L}_{1} + t \sqrt{Dk} ) + 2 {L}_{2}} \qquad ( Equation 1 )$$

The constant c, which is 3e8 meters/second, represents the speed of a light wave in free space. Also, t is the thickness of a substrate of the PCB 240, and Dk is the relative dielectric constant of the PCB 240. For example, in some embodiments, L₁=11 millimeters (“mm”), L₂=12 mm, t=1.0 mm, and Dk=4.4, thus resulting in f₀=3.93 GHZ. In general, L₁+t*sqrt(Dk) is the distance from the top of the parasitic element 210 to a reference plane (e.g., the flat ground plane of the PCB 240). Equation 1, however, does not account for the effect of the substrate 230 that supports the parasitic element 210. As a result, the estimated operating frequency of 3.93 GHZ may be slightly different from (e.g., 0.07 GHz lower than) a measured center frequency of the antenna 200.

FIG. 2B is a schematic front view of the substrate 230 having the parasitic element 210 of FIG. 2A thereon. Specifically, FIG. 2B shows a vertical cross-section taken along a horizontal line that passes through a pair of PTH vias 250 of FIG. 2A that are in the PCB 240. For simplicity of illustration, the feeding line 260 (FIG. 2A), a portion of which may extend between the substrate 230 and the PCB 240, is omitted from view in FIG. 2B.

As shown in FIG. 2B, the parasitic element 210 may have a plurality of vertical portions 211 (two, in this example) and a horizontal portion 212 that connects the vertical portions 211 to each other. The vertical portions 211 are horizontally spaced apart from each other and thus may be referred to herein as respective “legs” of the parasitic element 210. The horizontal portion 212 and the vertical portions 211 may all be on the front surface 230F of the substrate 230.

In some embodiments, the parasitic element 210 may have a symmetrical shape, such as a π (“Pi”) shape that has first and second vertical portions 211-1 and 211-2 that are spaced apart from each other by a distance that is shorter than the width L₂ (FIG. 2A) of the horizontal portion 212, as shown in FIG. 2B. The first and second vertical portions 211-1 and 211-2 may be grounded (i.e., connected to the ground plane of PCB 240) through respective PTH vias 250 of the PCB 240. Such a symmetrical structure, which may be provided by having exactly two (rather than one or three) vertical portions 211, can provide symmetrical current distribution, strong cancellation of horizontal currents, and symmetrical radiation patterns. Perfect cancellation of horizontal currents can indicate the best impedance match for the antenna 200. Moreover, the symmetrical structure may, in some embodiments, be non-circular and/or non-elliptical.

FIG. 2C is a schematic rear view of the substrate 230 of FIG. 2B. As shown in FIG. 2C, the active element 220 may be on the rear surface 230R of the substrate 230. Specifically, the active element 220 may be inside an outline formed by a combination of (i) an outline 213 of the parasitic element 210 and (ii) the PCB 240 (e.g., the ground plane thereof). In some embodiments, the outline 213 may not be visible from the rear surface 230R, as the parasitic element 210 is on the front surface 230F (FIG. 2B) of substrate 230. The outline 213 is depicted in FIG. 2C, however, to indicate a position of the parasitic element 210 relative to that of the active element 220.

The active element 220 may, in some embodiments, have a vertical portion 221 and a horizontal portion 222, each of which may be on the rear surface 230R and inside the combined outline formed by (i) the outline 213 of the parasitic element 210 and (ii) the PCB 240. In particular, the top of the horizontal portion 222 of the active element 220 may be below the bottom of the horizontal portion 212 (FIG. 2B) of the parasitic element 210. Moreover, the horizontal portion 222 and the vertical portion 221 of the active element 220 may both be between the vertical portions 211-1 and 211-2 (FIG. 2B) of the parasitic element 210. For example, as shown in FIG. 2C, the active element 220 may be a T-shaped element that is centered between vertical legs of the outline 213 (which legs represent respective vertical portions 211) of the parasitic element 210.

As discussed herein with respect to FIG. 2A, coupling between the parasitic element 210 and the active element 220 may be a combination of inductive coupling and capacitive coupling. Current in the antenna 200 may primarily flow along vertical portions 211, 221, each of which may be shorter than a quarter wavelength (24) of the center frequency of the operating frequency band of antenna 200, and preferably shorter than a quarter wavelength (24) of any frequency of the operating frequency band of antenna 200. As current flows in the vertical portions 211, 221, and as the vertical portions 211, 221 are located in close proximity to each other, they may act like inductors. Accordingly, the parasitic element 210 and the active element 220 may be inductively coupled to each other through the vertical portions 211, 221. Specifically, the vertical portion 221 of the active element 220 may be inductively coupled in a horizontal direction to one or both of the vertical portions 211-1, 211-2 of the parasitic element 210.

A horizontal distance between the vertical portion 221 and one or both of the vertical portions 211-1, 211-2 may be between, for example, 1 mm and 5 mm. Increasing the horizontal distance between the vertical portion 221 and the vertical portion(s) 211 may significantly decrease inductive coupling for the antenna 200. For example, increasing the horizontal distance from 2 mm to 4 mm may decrease mutual reactance from −53 ohms to −80 ohms. Increasing the horizontal distance from 2 mm to 4 mm may also increase bandwidth for the antenna 200. By reducing inductive coupling, the imaginary part of the input impedance of the antenna 200 may be almost entirely removed from 3.5 GHz to 4.5 GHz.

Moreover, accelerated charges may be deposited near the tops of the parasitic element 210 and the active element 220 and build capacitive coupling. Accordingly, the horizontal portion 212 of the parasitic element 210 may be capacitively coupled in a vertical direction to the horizontal portion 222 of the active element 220.

FIGS. 2D-2G are schematic rear views of modified embodiments of the antenna 200. FIG. 2D illustrates an example in which the active element 220 is not centered between vertical legs of the outline 213 of the parasitic element 210. Rather, the vertical portion 221 (and/or the horizontal portion 222) of the active element 220 is closer to the vertical portion 211-2 (FIG. 2B) of the parasitic element 210 than to the vertical portion 211-1 (FIG. 2B) of the parasitic element 210.

FIG. 2E illustrates that the active element 220 can omit the horizontal portion 222 (FIG. 2C) thereof and be a straight vertical line. For example, the active element 220 may have only a vertical portion 221′, which may, in some embodiments, be vertically longer than the vertical portion 221 of the T-shaped active element 220 that is shown in FIG. 2C. The vertical portion 221′ may be either centered or offset from a center point between vertical legs of the outline 213 of the parasitic element 210.

FIG. 2F illustrates a parasitic element 210 that is not supported by the substrate 230 (FIG. 2A). Rather, the substrate 230 may be omitted entirely, and the parasitic element 210 and the active element 220 may be sheet metal radiating elements that are mounted on the top surface 240T of the PCB 240.

FIG. 2G illustrates a folded active element 220F that is inside a combined outline formed by (i) the outline 213 of the parasitic element 210 and (ii) the PCB 240. Accordingly, the combined outline may enclose active (i.e., directly-fed) radiating elements of various shapes, not merely an active element 220 that is T-shaped or straight-line-shaped.

FIG. 2H is a schematic top view of a further embodiment of an antenna according to embodiments of the present invention. As shown in FIG. 2H, a first parasitic element 210-1 may cross a second parasitic element 210-2. Moreover, each of the parasitic elements 210-1, 210-2 may have an outline 213 (FIG. 2C) that extends around three sides of a respective active element 220 (FIG. 2A), such as a T-shaped active element 220 (FIG. 2C) or a folded active element 220F (FIG. 2G).

FIGS. 2I-2L are front perspective views of various antennas having two parasitic elements 210, such as the two parasitic elements 210-1, 210-2 of FIG. 2H, coupled to an active element 220X. In each of these antennas, all horizontal currents may cancel each other out to zero. Each active element 220X in these antennas is a type of monopole antenna element. Moreover, the parasitic elements 210 can have an axially-symmetrical geometry or separated symmetrical geometries.

For simplicity of illustration, the substrate 230, the PCB 240, and the feeding line 260 that are shown in FIG. 2A are omitted from view in FIGS. 2I-2L. Moreover, the active element 220X and the parasitic elements 210 may, in some embodiments, be sheet metal radiating elements that are mounted on the PCB 240 rather than printed on the substrate 230, and the substrate 230 thus may be omitted entirely.

As shown in FIG. 2I, two parasitic elements 210-1, 210-2 may cross each other at the same vertical level, such that respective horizontal portions 212 of the two parasitic elements 210-1, 210-2 may contact each other. The two parasitic elements 210-1, 210-2 may each be coupled to a monopole active element 220X that is formed by crossing two T-shaped active elements (FIG. 2C) with each other. Accordingly, the active element 220X may be X-shaped when viewed in a plan view. Moreover, surfaces of the active element 220X may be offset from (rather than parallel to) surfaces of the two parasitic elements 210-1, 210-2, such as rotated by 45 degrees. For example, the active element 220X may include two vertical portions 221-1, 221-2 that intersect (e.g., may be perpendicular to) each other, as well as two horizontal portions 222-1, 222-2 that intersect (e.g., may be perpendicular to) each other, where each portion 221-1, 221-2, 222-1, 222-2 may form a 45-degree angle with each horizontal portion 212 of the parasitic elements 210-1, 210-2.

As shown in FIG. 2J, an antenna may have two parasitic elements 210-1G, 210-2G that each have a gap G in their respective horizontal portions 212G. Each gap G is an opening/discontinuity that overlies an active element 220X. Moreover, each of the two parasitic elements 210-1G, 210-2G may, in some embodiments, be parallel to (rather than offset from) a respective surface of the active element 220X.

As shown in FIG. 2K, an antenna may have two parasitic elements 210-1, 210-2 that are parallel to (rather than offset/rotated relative to) respective surfaces of the active element 220X.

As shown in FIG. 2L, an antenna may have two parasitic elements 210-1, 210-2 that have different respective heights. Specifically, vertical portions 211 of the parasitic element 210-1 may be longer than vertical portions 211 of the parasitic element 210-2. In some embodiments, a horizontal portion 212 of the parasitic element 210-1 may be spaced apart from (and thus may not contact) a horizontal portion 212 of the parasitic element 210-2.

An antenna 200 (FIG. 2A) that includes a parasitic element 210 (FIG. 2A) according to embodiments of the present invention may provide a number of advantages. These advantages include broadened bandwidth relative to a narrower bandwidth provided by a conventional compact monopole antenna. For example, by coupling an active element 220 (FIG. 2A) of the antenna 200 to the parasitic element 210, the bandwidth of the antenna 200 may be wider than a bandwidth that would be provided by the active element 220 alone. As an example, the bandwidth of the antenna 200 may range from about 3.5 GHz to about 4.5 GHZ. Moreover, the bandwidth may, in some embodiments, extend below 3.5 GHz and/or above 4.5 GHz. According to some embodiments, the bandwidth may include much lower frequencies, such as 1.7 GHZ. The antenna 200 may be used in various systems/apparatuses, including a small-cell base station 130 (FIG. 1), a Wi-Fi access point 140 (FIG. 1), a macrocell base station 120 (FIG. 1), a DAS, and a cell phone (or other portable wireless electronic device, which may be, for example, inside a building 102 (FIG. 1)).

Moreover, by having the parasitic element 210 and the active element 220 on opposite surfaces 230F (FIG. 2B) and 230R (FIG. 2C), respectively, of a substrate 230 (FIG. 2A), the antenna 200 may be more compact than if the parasitic element 210 and the active element 220 were on the same surface of the substrate 230. Otherwise, the parasitic element 210 and the active element 220 might need more distance therebetween to reduce the increased coupling that can result from being on the same surface of the substrate 230. Accordingly, the antenna 200 can be compact in addition to having a broadened bandwidth.

The present invention has been described above with reference to the accompanying drawings. The present invention is not limited to the illustrated embodiments. Rather, these embodiments are intended to fully and completely disclose the present invention to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

That which is claimed is:

1. An antenna comprising:
a ground plane;
a parasitic element coupled to the ground plane; and
an active element having a vertical portion and a horizontal portion that are each inside an outline provided by a combination of the parasitic element and the ground plane,
wherein the parasitic element is coupled to the active element.

2. The antenna of claim 1, wherein the parasitic element has a symmetrical shape.

3. The antenna of claim 2, wherein the active element and the parasitic element comprise T-shaped and Pi-shaped radiating elements, respectively.

4. The antenna of claim 1, wherein the active element is centered between vertical legs of the outline.

5. The antenna of claim 1,
wherein the parasitic element comprises first and second vertical portions, and
wherein the vertical portion of the active element is closer to the second vertical portion of the parasitic element than to the first vertical portion of the parasitic element.

6. The antenna of claim 1, further comprising a substrate having a first surface and a second surface that is opposite the first surface,
wherein the parasitic element and the active element are on the first surface of the substrate and the second surface of the substrate, respectively.

7. The antenna of claim 6,
wherein the ground plane comprises a ground plane of a printed circuit board (PCB), and
wherein the substrate is on a surface of the PCB.

8. The antenna of claim 7,
wherein the PCB comprises first and second plated through hole (PTH) vias therein, and
wherein the parasitic element comprises first and second vertical portions that are coupled to the ground plane through the first and second PTH vias, respectively.

9. A monopole antenna comprising:
a parasitic element having a horizontal portion and first and second vertical portions; and
an active element having a vertical portion and a horizontal portion,
wherein the parasitic element of the monopole antenna is inductively and/or capacitively coupled to the active element of the monopole antenna.

10. The monopole antenna of claim 9, wherein the parasitic element is both capacitively coupled and inductively coupled to the active element.

11. The monopole antenna of claim 10,
wherein the horizontal portion of the parasitic element is capacitively coupled to the horizontal portion of the active element, and
wherein at least one of the first and second vertical portions of the parasitic element is inductively coupled to the vertical portion of the active element.

12. An antenna comprising an active portion and a parasitic portion that are on opposite surfaces, respectively, of a first printed circuit board (PCB).

13. The antenna of claim 12, further comprising a second PCB having a surface that has the first PCB thereon.

14. The antenna of claim 13, wherein the opposite surfaces of the first PCB are perpendicular to the surface of the second PCB.

15. The antenna of claim 13,
wherein the second PCB comprises first and second plated through hole (PTH) vias therein, and
wherein the parasitic portion of the antenna is grounded through the first and second PTH vias.

16. The antenna of claim 13,
wherein the parasitic portion of the antenna comprises a horizontal portion having a first length, and
wherein a second length from a top of the horizontal portion to the surface of the second PCB is shorter than the first length.

17. The antenna of claim 13, wherein the parasitic portion of the antenna comprises:
a horizontal portion extending a first distance in a direction parallel to the surface of the second PCB; and
first and second vertical portions that are spaced apart from each other by a second distance that is shorter than the first distance.

18. The antenna of claim 12, wherein the parasitic portion of the antenna is both capacitively coupled and inductively coupled to the active portion of the antenna.

19. The antenna of claim 12, wherein the active portion of the antenna is a straight line on the first PCB.

20. The antenna of claim 12, wherein the active portion of the antenna comprises a horizontal portion and a vertical portion.
